(19) United States
(12) Patent Application Publication
(10) Pub. No.: US 2007/0108276 A1
(43) Pub. Date: May 17, 2007

(54) One key rule product matching shopping contest

(76) Inventor: Dino Scorziello, Akron, OH (US)

Correspondence Address: DINO SCORZIELLO, 2037 WILMICH DR., AKRON, OH, 44319, US

(21) Appl. No.: 11/653,455

(22) Filed: Jan. 16, 2007

Related U.S. Application Data
(63) Continuation-in-part of application No. 11/022,591, filed on Dec. 28, 2004.

(51) Int. Cl. G06K 15/00; G06Q 20/00

(52) U.S. Cl. 235/383; 705/16

(57) ABSTRACT

A retail contest consisting of one key rule for winning (60) which is made public (65) to customers (2), a product database (30) containing the items for sale in a store, a designated winning-list of items (40) containing a minimum of two items selected from the product database (30) and an electronic cash register or computer with product identification means (20) that can identify the items (10) a contestant (1) is purchasing (15). The key rule for winning (60) requires contestants (1) to purchase (15) all the items on the designated winning-list of items (40). The electronic cash register or computer with product identification means (20) can also compare (25) the items being purchased (10) against the items listed in the designated winning-list of items (40). The result of the comparison is then transmitted to the contestant (50) either visually, audibly, in printed form or any combination of visual, audible or printed form.

### CROSS-REFERENCE TO RELATED APPLICATIONS

This invention is a continuation in part of: application Ser. No.: 11/022,591

### BACKGROUND

1. Field of the Invention

This invention relates to contests conducted by retailers, specifically to such contests which requires shoppers to purchase specific items in order to win.

2. Description of Prior Art

Retailers normally have contests that require contestants to fill out a ballot and wait for a random drawing, on a designated date, in order to select a winner. However, most shoppers are in too much of a rush to fill out a ballot, and they are wary of writing their contact information on a ballot that will be given to third parties such as tele-marketers later on. To avoid these inconveniences most eligible contestants decide not to enter most retail contests. Consequently, retailers wanting to promote their stores or products find it difficult to get disenfranchised consumers to enter their contests.

Other retail contests require customers to purchase only certain, more expensive items in order to have a chance at winning the contest. For example, fast food restaurants conducting contests usually require customers to purchase the larger, more expensive menu items, in order to receive a game piece and thus obtain a possibility of winning a prize. This prevents other customers who can't afford the more expensive items or who didn't want to order those food categories, from participating in the contest. Contests such as these alienate customers who do not order the designated menu items, causing resentment and the future loss of sales.

Promotional systems such as U.S. Pat. No. 6,634,550 (Game Presentation in a Retail Establishment) contains a database that associates products with rules for winning coupons. In this system customers have no knowledge of what the rules are beforehand and thus do not know what they have to do to win a coupon. This can have a disenfranchising effect on a customer if he/she sees another customer receive a coupon for purchasing the same item(s) as he/she did, but was not rewarded. The customer who receives nothing will feel that the game is “rigged” and unfair since he/she will want the same reward. A store risks losing customers for not publicizing the rules stored in the database. However, if they did publicizing the rules in the database customers would take full advantage of them, to their benefit, especially if the value of the prize increases.

It would be beneficial to both customers and retailers if an appreciation contest existed that is easy to enter, and contained only one simple key rule to win which would be general knowledge to everyone who participates.

Furthermore, many retailers work with charities and like to help improve their communities by asking for donations from their customers or by donating a portion of their profits. It would be beneficial to combine an appreciation contest with the ability to help a charity by asking participants for a nominal sum of money that would help charities in exchange for increasing the value of the prize awarded, if they should win.

### SUMMARY

In accordance with the present invention, a retail contest consists of products for sale in a store or restaurant, a database of the items for sale in the store or restaurant, a winning-list of items pre-selected from the store's product database, and an electronic cash register or computer that can identify the items being purchased and which is connected to or contains the store's product database and winning-list of items, in its memory. The key rule to winning the contest requires customers to purchase all the items on the winning-list of items. Customers are made aware of the requirement of winning the contest prior to making a purchase either through advertisements or disclosure from the cashier.

When a purchase is made, the electronic cash register or computer identifies each item and compares the items purchased to those contained in the winning-list of products. If the items purchased match all the items on the winning-list, then the customer wins a reward. If the items purchased do not match all the items on the winning-list, then the customer does not receive a reward. In either case the result is transmitted to the customer.

Objects and Advantages

Accordingly, several objects and advantages of my invention are:
a) to provide retailers a contest that will ensure a large entrant to customer ratio.
b) to provide customers with an easy, convenient way to be entered in a contest given by a retailer.
c) to provide customers a way to participate in a contest without limiting their eligibility to the purchase of special or expensive items.
d) to provide customers a way to participate in a contest and know, at the time of purchase whether they will receive a reward or not.
e) to provide retailers with a contest that will not disenfranchise customers by causing them inconveniences in order to enter the contest or by having their contact information given to third parties.
f) to provide retailers with a contest that contains one key rule.
g) to provide customers with a contest in which the key rule for winning is disclosed to them before participating.
h) to provide customers with a way to help charities while participating in a contest in which they could win a prize.
i) to provide retailers with a way to help charities and garner good will and affection from customers.

Further objects and advantages are to provide a contest, which can be easily and conveniently, conducted using databases and checkout equipment already in use by the retailer. Still further objects and advantages will become apparent from a consideration of the ensuing description and drawing.

### DRAWING FIGURES

FIG. 1 shows a flowchart describing how a customer enters a retail contest and how to determine if he/she is given a reward or not, based on the items he/she purchases.

FIG. 2 shows the retail contest described in FIG. 1 wherein a nominal sum of money is paid before a result is determined.

### REFERENCE NUMERALS IN DRAWINGS

1—contestant
2—customer
5—shopping
10—items to be purchased
15—purchase/check out
20—electronic cash register or computer with product identification means
25—compare
30—product database
40—designated winning-list of products
45—determination
50—transmit result
60—key rule for winning
65—public disclosure
70—nominal sum of money

### DESCRIPTION

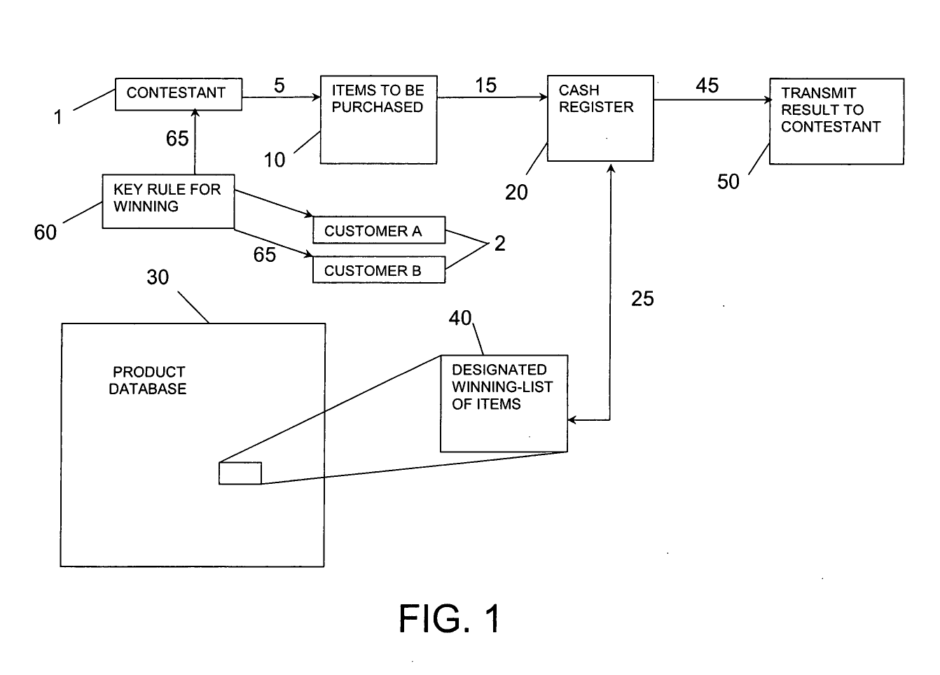

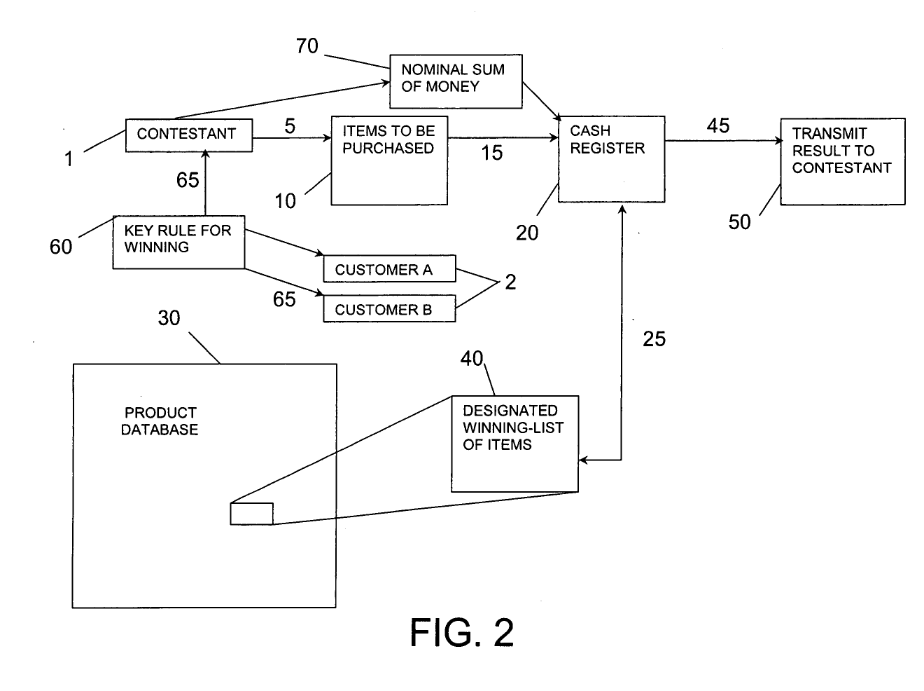

### FIGS. 1 and 2—Preferred Embodiment

FIG. 1 shows how a contestant 1 enters a product matching shopping contest and how to determine if he/she is given a reward or not based on the items 10 he/she purchases 15. A contestant 1 is a customer 2 of a business conducting a product matching shopping contest to which the key rule for winning 60 is known.

Stores maintain a comprehensive list of all the products they offer for sale to their customers. An electronic version of this list stored in a computer's memory is called the store's product database 30. The product database 30 is usually updated and manipulated using database software such as Microsoft Access or Excel. From the store's product database 30, a subset of items is selected to form the designated winning-list of items 40. The designated winning-list of items 40 consists of a minimum of two items or a plurality of items from the store's product database 30.

The key rule for winning 60 is the instruction that a contestant 1 must adhere to in order to win the contest. The key rule for winning 60 requires contestants 1 to purchase/check out 15 all the items on the designated winning-list of products 40. The key rule for winning 60 is advertised and publicly disclosed 65.

The contestant 1 will be shopping 5 for items to be purchased 10. The items to be purchased 10 are whatever the contestant 1 desires to buy at that store at that time. The contestant 1 must purchase/checkout 15 the items 10 using an electronic cash register or computer with product identification means 20 (also known in the art as a Point of Sale). The electronic cash register or computer with product identification means 20 must also have the means to compare 25 the items to be purchased 10 against the designated winning-list of items 40. The electronic cash register or computer with product identification means 20 must also have the means to come to a determination 45 as to whether the contestant 1 wins or loses. The electronic cash register or computer with product identification means 20 must also have the means to transmit the result 50 of the determination 45 when the determination process is complete. The result may be transmitted audibly, visually on a display screen, printed on a receipt or any combination of audible, visual or printed form.

The electronic cash register or computer with product identification means 20 must also be able to ask for and accept the nominal sum of money 70 seen in FIG. 2. The nominal sum of money 70 is a small amount of money set by the retailer.

Advantages

From the description above, several advantages of my product matching shopping contest become evident:

(a) The product matching shopping contest can be easily conducted by on-line, Internet based retailers.

(b) Companies that sell services can also use this method to conduct a contest. In this case, services will be purchased instead of or in combination with products.

(c) The product matching shopping contest is quick to conduct and utilizes equipment and software already in use by the retailer.

(d) The use of one key rule that is made public will not disenfranchise contestants that do not win since everyone will know that they were all treated equally.

(e) Inclusion of the nominal sum of money will allow retailers to collect donations for charities.

Operation—FIGS. 1, 2

The manner of operating the product matching shopping contest invention is illustrated in FIG. 1. The key rule for winning 60 the product matching shopping contest is publicly disclosed 65 to customers 2. It can be made public by advertising it in the store, on media such as newspapers, radio, television, the internet, etc., or it can be disclosed to customers 2 in person. The key rule for winning 60 requires contestants 1 to purchase/check out 15 all the items on the designated winning-list of products 40. A contestant 1 conducts his/her shopping 5 and collects items to be purchased 10. When the contestant 1 has completed shopping he/she will purchase/check out 15 the items by allowing an electronic cash register or computer with product identification means 20 to identify their selected items 10. The electronic cash register or computer with product identification means 20 will compare 25 the items being purchased 10 against those on the designated winning-list of items 40 which is chosen from the larger product database 30. The designated winning-list 40 of items must contain a minimum of two items from the product database 30. Otherwise someone could decide to systematically purchase every item for sale until he/she wins thus spoiling the intent of the appreciation contest. It becomes more of a challenge to try to purchase two or more items in order to win.

The electronic cash register or computer with product identification means 20 will also determine 45 if all the items on the designated winning-list of items 40 were purchased. If all the items on the designated winning-list of items 40 were purchased by the contestant 1 then the electronic cash register or computer with product identification means 20 will transmit a win result 50 to the contestant 1, either visually, audibly, in printed form or any combination of visual, audible or printed form. If all the items on the designated winning-list of items 40 were not purchased by the contestant 1 then the electronic cash register or computer with product identification means 20 will transmit a lose result 50 to the contestant 1, either visually, audibly, in printed form or any combination of visual, audible or printed form.

In FIG. 2, a nominal sum of money 70 is collected from the contestant 1 before a result determination 45 is made. This will allow retailers to entice contestants 1 to try to win more valuable prizes. It will also allow them to collect money for charities. It will not alter the contestant's 1 chance of winning the contest.

### CONCLUSION, RAMIFICATIONS AND SCOPE

Accordingly, the reader will see that the product matching shopping contest invention can be conducted by a retailer easily and conveniently. Contestants can participate in such a contest without being inconvenienced to fill out an entry ballot and they can know whether they will receive a reward or not when they complete their purchase. The contest does not disenfranchise customers by collecting their contact information and then distribute it to tele-marketers or other third parties. Moreover, it prevents disenfranchising customers by disclosing the key rule for winning to the public in advance of participation, assuring customers that everyone is treated equally. It also allows for more customer participation by not restricting what they can buy in order to participate in the contest. It can also be used to collect money for charities.

This invention also has the advantage of being able to be used by on-line, Internet based retailers. Also, this invention can have a product database that includes services or a combination of products and services. For example an automotive service company's database may contain products such as shock absorbers and services such as oil changes. Their designated winning-list of items can consist of a combination of products and services.

While my above description contains many specificities, these should not be construed as limitations on the scope of the invention, but rather as an exemplification of one preferred embodiment thereof. Many variations are possible. For example customers may be eligible to win special prizes on certain dates of the year or days of the week in order to entice customers to shop on those days.

Accordingly, the scope of the invention should be determined not by the embodiments illustrated, but by the appended claims and their legal equivalents.

I claim:

1. A shopping contest, comprising of:
(a) a designated winning-list of products or services, containing a minimum of two products or services, selected from a larger list of products or services,
(b) a publicly known rule requiring contestants to purchase all the items on said designated winning-list of products or services,
whereby a contestant is a winner if the items he/she purchased match the items on said designated winning-list of items.

2. The shopping contest of claim 1 wherein a nominal sum of money is collected.
